(19) United States
(12) Patent Application Publication
(10) Pub. No.: US 2021/0103396 A1
(43) Pub. Date: Apr. 8, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Koki TOSHIMITSU, Kanagawa (JP)

(73) Assignee: FUJI XEROX CO., LTD., Tokyo (JP)

(21) Appl. No.: 16/853,659

(22) Filed: Apr. 20, 2020

(30) Foreign Application Priority Data
Oct. 4, 2019 (JP) 2019-184124

(51) Int. Cl. G06F 3/06

(52) U.S. Cl. CPC G06F 3/0631; G06F 3/0653; G06F 3/067; G06F 3/0619; G06F 3/0659

(57) ABSTRACT

An information processing apparatus includes a processor configured to: store an operation history of an operation performed for a first storage area allocated to a user, in a second storage area that is not allocated to any user; and check an available capacity of the first storage area each time a predetermined process is performed, and when the first storage area has the available capacity equal to or larger than at least a size of the operation history, perform control to change a storage destination of the operation history from the second storage area to the first storage area.

### CROSS-REFERENCE TO RELATED APPLICATIONS

This application is based on and claims priority under 35 USC 119 from Japanese Patent Application No. 2019-184124 filed Oct. 4, 2019.

### BACKGROUND

### 1. Technical Field

The present disclosure relates to an information processing apparatus and a non-transitory computer readable medium.

### 2. Related Art

JP-A-2018-103466 discloses an image forming apparatus including a box management unit that sets upper limit values for usage amounts of user boxes of plural users, and a box storage processor that stores data of a user among the plural users in a specific user box of the user while preventing the data from exceeding the upper limit value of the usage amount. The box storage processor determines whether an available capacity of the specific user box is insufficient for the storage of the data, and when it is determined that the available capacity of the specific user box is insufficient, the box management unit specifies the shortage amount of the specific user box for the storage of the data, temporarily reduces the upper limit values for the usage amounts of the other user boxes, and temporarily increases the upper limit value for the usage amount of the specific user box at least as much as the shortage.

### SUMMARY

With the distribution of business systems using networks, the importance of data management is increasing, and it is required to store an operation history of data as an audit trail in a storage device, in order to verify who has registered, deleted, read or corrected data, and when data has been registered, deleted, read or corrected, at a later time.

For the verification of data management, it is presumed that an operation history has been stored in a storage device. Thus, for example, when a storage area where a data operation has been performed by a user has no available capacity for storing an operation history, processes may be performed such as temporarily reducing an upper limit of the capacity of another storage area having an available capacity, and then, increasing the upper limit of the capacity of the storage area where the data operation has been performed, to store the operation history.

However, in this case, it is necessary to perform processes of checking not only the capacity of the storage area where the data operation has been performed but also the capacity of another storage area, and then, changing the upper limit of the capacity of the storage area. Thus, an amount of a process required to store the operation history increases, as compared with a case where the operation history is stored without changing the capacity of the storage area.

Aspects of non-limiting embodiments of the present disclosure relate to an information processing apparatus and a non-transitory computer readable medium that are capable of reducing an amount of a process required to store an operation history in a designated storage area, as compared with a case where an operation history of a storage area is stored in the designated storage area by changing the capacity of the storage area when the storage area has no available capacity.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: store an operation history of an operation performed for a first storage area allocated to a user, in a second storage area that is not allocated to any user; and check an available capacity of the first storage area each time a predetermined process is performed, and when the first storage area has the available capacity equal to or larger than at least a size of the operation history, perform control to change a storage destination of the operation history from the second storage area to the first storage area.

### BRIEF DESCRIPTION OF THE DRAWINGS

Exemplary embodiment(s) of the present disclosure will be described in detail based on the following figures, wherein:

FIG. 1 is a diagram illustrating an example of a configuration of an information processing system;

FIG. 2 is a functional block diagram illustrating an example of a functional configuration of an information processing apparatus;

FIG. 3 is a diagram illustrating an example of a configuration of components in an electric system of the information processing apparatus;

FIG. 4 is a flowchart illustrating an example of the flow of an upload process according to a first exemplary embodiment;

FIG. 5 is a view illustrating an example of a menu screen;

FIG. 6 is a view illustrating an example of an upload screen;

FIG. 7 is a view illustrating an example of the menu screen when an upload of document data is successful;

FIG. 8 is a view illustrating an example of a warning screen;

FIG. 9 is a flowchart illustrating an example of the flow of a deleting process according to the first exemplary embodiment;

FIG. 10 is a view illustrating an example of a confirmation screen when document data is deleted;

FIG. 11 is a view illustrating an example of the confirmation screen when an operation history is stored in a system area;

FIG. 12 is a flowchart illustrating an example of the flow of an upload process according to a second exemplary embodiment;

FIG. 13 is a flowchart illustrating an example of the flow of a deleting process according to the second exemplary embodiment; and

FIG. 14 is a flowchart illustrating an example of the flow of a changing process.

### DETAILED DESCRIPTION

Hereinafter, exemplary embodiments of the present disclosure will be described with reference to the accompanying drawings. The same components and the same processes in the drawings will be denoted by the same reference numerals throughout the drawings, and overlapping descriptions thereof will be omitted.

### First Exemplary Embodiment

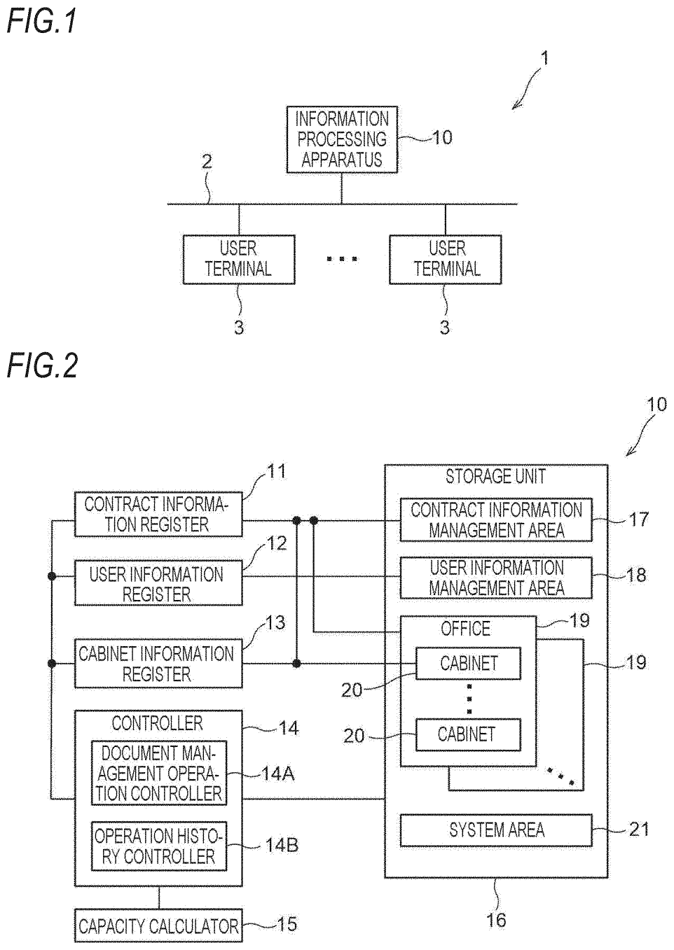

FIG. 1 is a diagram illustrating an example of a configuration of an information processing system 1 that implements a document management service. The document management service is a service storing a document created by a contracting company that makes a contract for the document management service, storing an operation history indicating contents of an operation on a document such as registration, deletion, reading or correction of a document, for each operation as an audit trail in a storage device, and providing the operation history as a material for data auditing in the company.

The information processing system 1 includes user terminals 3 and an information processing apparatus 10, and the user terminals 3 and the information processing apparatus 10 are connected to each other via a communication line 2.

Each user terminal 3 is a device used by a user who belongs to the contracting company of the document management service. Each user terminal 3 has a communication function such as, for example, a desktop computer, a tablet computer, a smartphone or a wearable terminal. As the user terminal 3, an information device is employed that implements registering a document to the information processing apparatus 10 via the communication line 2, and at least one of reading, deleting, or correcting a document stored in the information processing apparatus 10.

The number of user terminals 3 included in the information processing system 1 is not limited, and the number of user terminals 3 that conform to the contract of the document management service are connected to the information processing apparatus 10.

The information processing apparatus 10 is managed by a service provider that provides the document management service. The information processing apparatus 10 stores a document registered by a user of the contracting company of the document management service, stores an operation history of a user's operation on a document for each contracting company, and provides the operation history according to a request from the user. Hereinafter, for the convenience of description, the contracting company of the document management service will be simply referred to as the “contracting company”, and a user who belongs to the contracting company will be simply referred to as the “user”.

The communication line 2 may be a wired or wireless line, or may be a line in which a wired line and a wireless line co-exist. In addition, the communication line 2 may be a dedicated line or a public line such as the Internet that is shared by multiple unspecified information devices.

FIG. 2 is a functional block diagram illustrating an example of a functional configuration of the information processing apparatus 10. The information processing apparatus 10 includes functional units such as a contract information register 11, a user information register 12, a cabinet information register 13, a controller 14, a capacity calculator 15, and a storage unit 16.

Meanwhile, the storage unit 16 includes a contract information management area 17, a user information management area 18, an office 19, and a system area 21, and the office 19 includes at least one cabinet 20.

The contract information register 11 stores contract contents that are received from a user via the communication line 2 and indicate contents of a contract made with the contracting company for the document management service, for each contracting company in the contract information management area 17 provided in advance in the storage unit 16. The contract contents include, for example, information such as a name of the contracting company, contact information of the contracting company, a contracted period, and a total storage capacity allocated to the contacting company for storing document data. The total storage capacity allocated to the contracting company for storing document data is set in advance according to the contract, and a user may not store document data that exceed the total storage capacity allocated by the information processing apparatus 10, in the information processing apparatus 10. That is, an upper limit capacity of a storage area that may be used by one contracting company for storing document data is determined in advance.

The storage area of document data that is allocated in advance for each contracting company is called an “office 19”. In the storage unit 16, one office 19 is created for a contract with a contracting company. In addition, the “document data” refers to a set of data which is an entity of a document and conforms to a predetermined file format. Meanwhile, the “document” refers to an object that includes document data and is operated by a user.

The user information register 12 stores user information that is received from a user via the communication line 2 and indicates information of a user who uses the office 19, in the user information management area 18 provided in advance in the storage unit 16. The user information includes, for example, user identification information used for identifying a user such as a user's name or user ID of a user in the contracting company, and a user's attribute such as a department to which a user belongs or a user's position, and an authority to access a document.

The user information register 12 registers, deletes, reads, and corrects the user information based on an instruction from a user. Only a user registered in the user information management area 18 may perform an operation permitted by the authority to access a document.

The cabinet information register 13 creates the cabinet 20 in the office 19 according to an instruction received from a user via the communication line 2. The cabinet 20 is a document management object in which document data is to be stored, and document data registered in the information processing apparatus 10 is stored in a specific cabinet 20. Specifically, the document data is stored in any one “drawer” of a document data that is created in the cabinet 20. Further, the cabinet 20 stores an operation history for an operation on the document data that has been performed in the corresponding cabinet 20.

Plural cabinets 20 may be created in one office 19, and plural drawers may be created in one cabinet 20. The number of cabinets 20 created in the office 19, the number of drawers created in the cabinet 20, and the storage capacity of each cabinet 20 are set by a user. As a matter of course, a user may not create cabinets 20 that exceed the upper limit capacity of the office 19, in the office 19.

However, even after the storage capacity of the cabinet 20 is set, a user may freely change an upper limit capacity Cₘ of the cabinet 20, as long as the upper limit capacity Cₘ of the cabinet 20 does not exceed the upper limit capacity of the office 19.

In addition, for each cabinet 20, a user permitted to use the cabinet 20 is set by the user information register 12, and stored in the user information management area 18. The cabinet 20 is an example of a first storage area allocated to a user.

In addition, the number of cabinets 20 created in the office 19, and a consumed capacity C and the upper limit capacity Cₘ of each cabinet 20 are stored in the contract information management area 17.

The controller 14 includes a document management operation controller 14A and an operation history controller 14B. The document management operation controller 14A performs a control for performing an operation of a document in response to an instruction received from a user.

In this case, the document management operation controller 14A creates information necessary for an audit trail and notifies the information to the operation history controller 14B. The information includes, for example, operation date/time when an operation on a document is performed, user identification information for identifying a user who has performed the operation, an operation type, a document name of the operated document data, cabinet identification information for identifying the cabinet 20 such as a name of the cabinet 20 that stores the operated document or a cabinet number uniquely associated with the cabinet 20 designated by the operation, user terminal identification information for specifying the user terminal 3 that has requested the operation, and an operation result. The cabinet identification information is an example of identification information for identifying the first storage area where an operation has been performed by a user.

In addition, when an operation is performed causing a change in available capacity of the cabinet 20 such as registration, deletion, and correction of a document, the document management operation controller 14A requests the capacity calculator 15 to re-calculate the consumed capacity C of the cabinet 20 where the operation on the document has been performed.

When the information necessary for an audit trail is received from the document management operation controller 14A, the operation history controller 14B creates an operation history based on the information, and performs control to store the operation history in the cabinet 20 that includes the document data operated by the user, or the system area 21.

From the viewpoint of auditing data, the operation history may be stored together in the cabinet 20 that stores the operated document or the cabinet 20 designated as a registration destination of the document. However, the cabinet 20 may have no available capacity, and thus, may not store the operation history. Accordingly, when it is attempted to store the operation history in the cabinet 20, the operation history controller 14B requests the capacity calculator 15 to re-calculate the consumed capacity C of the cabinet 20 after the operation history is stored in the cabinet 20. When the size of the operation history exceeds the available capacity of the cabinet 20, the operation history controller 14B stores the operation history in the system area 21 until the available capacity equal to or larger than the size of the operation history is generated in the cabinet 20.

Hereinafter, the cabinet 20 that stores the operated document that is indicated by the operation history, or the cabinet 20 designated as a registration destination of the document will be collectively referred to as the “cabinet 20 where the operation indicated by the operation history has been performed”. In addition, an operation of registering document data in the cabinet 20 designated from the user terminal 3 will be referred to as “upload”, and an operation of reading document data stored in the designated cabinet 20 to the user terminal 3 will be referred to as “download”. In addition, the details of the process of storing the operation history will be described later.

When a request for re-calculating the consumed capacity C of the cabinet 20 is received from the document management operation controller 14A or the operation history controller 14B, the capacity calculator 15 calculates the consumed capacity C of the requested cabinet 20. Further, when it is requested from the document management operation controller 14A or the operation history controller 14B to determine whether designated data may be stored in the designated cabinet 20, the capacity calculator 15 adds the size of the designated data to the consumed capacity C of the designated cabinet 20, and determines whether the consumed capacity C of the cabinet 20 exceeds the upper limit capacity Cₘ of the cabinet 20, that is, whether the designated data may be stored in the designated cabinet 20. The capacity calculator 15 notifies the determination result to the source that has requested the determination.

When the determination result is received from the capacity calculator 15, the document management operation controller 14A or the operation history controller 14B performs control to store the operation on the document or the operation history, according to the determination result. The process will be described in detail later.

The system area 21 is a storage area provided in advance in the storage unit 16. When the operation history is temporarily stored in the system area 21 based on the control of the operation history controller 14B, and thereafter, an available capacity is generated in the cabinet 20 where the operation indicated by the operation history has been performed, the storage destination of the operation history is changed from the system area 21 to the cabinet 20.

While the system area 21 is a storage area that stores operation histories of operations performed for documents by various users who belong to different contracting companies, only the information processing apparatus 10 is able to store data in the system area 21, and a user may not store document data by designating the system area 21 as a storage destination. Thus, unlike the cabinet 20, the system area 21 is a storage area which is not allocated to any user, and is an example of a second storage area.

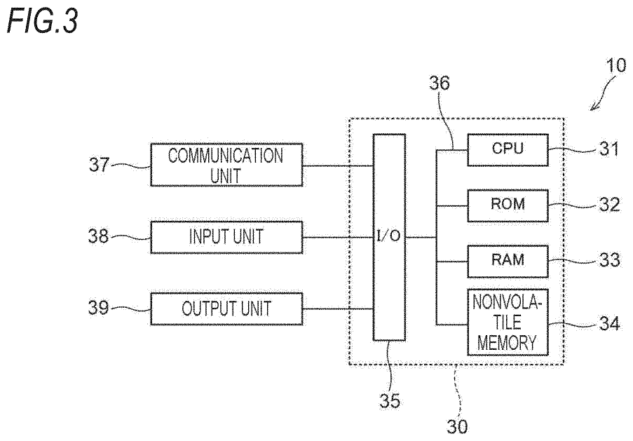

FIG. 3 is a diagram illustrating an example of a configuration of components in an electric system of the information processing apparatus 10. The information processing apparatus 10 is configured using, for example, a computer 30.

The computer 30 includes a CPU (central processing unit) 31 which is an example of a processor that executes the respective functions of the information processing apparatus 10, a ROM (read only memory) 32 that stores an information processing program for causing the computer 30 to function as the information processing apparatus 10, a RAM (random access memory) 33 that is used as a temporary work area of the CPU 31, a nonvolatile memory 34, and an input/output interface (I/O) 35. The CPU 31, the ROM 32, the RAM 33, the nonvolatile memory 34, and the I/O 35 are connected to each other via a bus 36.

The nonvolatile memory 34 is an example of a storage device that maintains stored data even when power supplied to the nonvolatile memory 34 is cut off. For example, a semiconductor memory is used, and a hard disk may also be used. The nonvolatile memory 34 does not need to be built in the computer 30, and may be a portable storage medium that is attachable to and detachable from the computer 30 such as a USB (universal serial bus) memory or a memory card.

For example, a communication unit 37, an input unit 38, and an output unit 39 are connected to the I/O 35.

The communication unit 37 is connected to the communication line 2, and includes a communication protocol that performs a data communication with each user terminal 3 connected to the communication line 2 and an external device (not illustrated) connected to the communication line 2.

The input unit 38 receives an instruction from a user and notifies the CPU 31 of the instruction. For example, a button, a touch panel, a keyboard, a mouse or the like is used. When a voice instruction is made, a microphone may be used as the input unit 38.

The output unit 39 is a device that outputs information processed by the CPU 31, and for example, a liquid crystal display, an organic EL (electro luminescence) display, a projector or the like is used.

The units connected to the I/O 35 of the computer 30 are not limited to those illustrated in FIG. 3, and another unit such as, for example, an image forming unit that forms an image on a recording medium may be connected to the I/O 35 as necessary.

Next, the operation of the information processing apparatus 10 will be described.

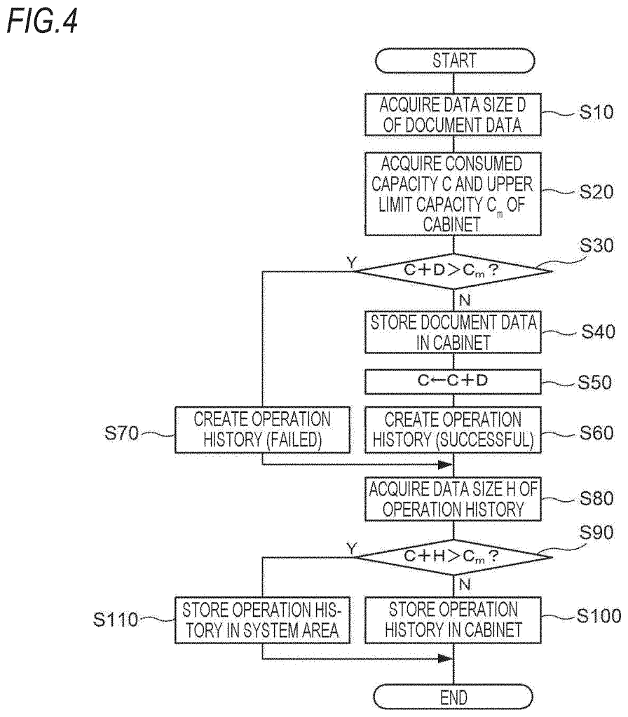

FIG. 4 is a flowchart illustrating an example of the flow of an upload process performed by the CPU 31 of the information processing apparatus 10, when a request for uploading document data to the cabinet 20 designated by the user of the user terminal 3 is made from the user terminal 3.

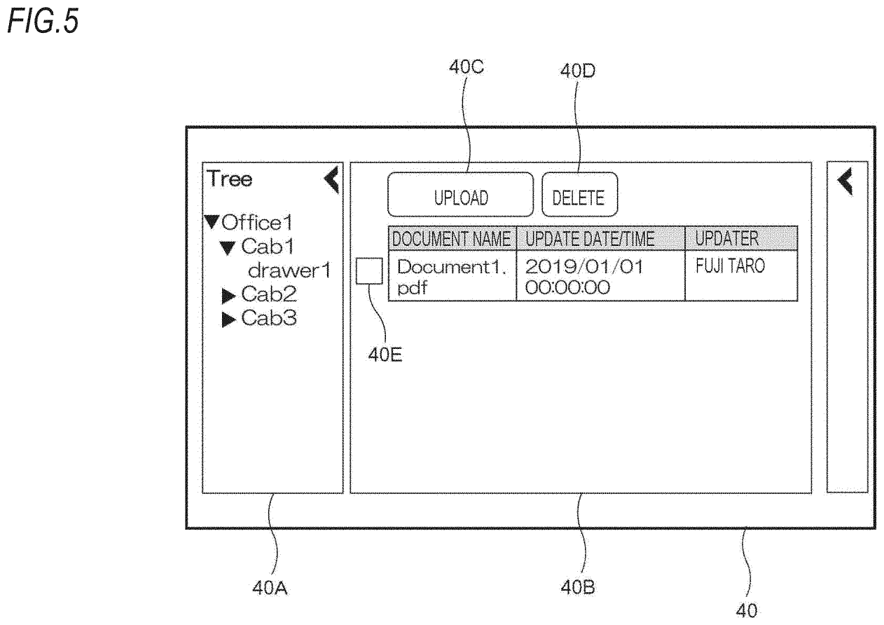

The user performs an operation on a document from a menu screen 40 displayed on the user terminal 3 as illustrated in FIG. 5. The menu screen 40 includes, for example, a designation screen 40A for designating a cabinet 20 and a display screen 40B that displays document data stored in the designated cabinet 20.

When it is desired to upload document data to the cabinet 20, the user designates the cabinet 20 which is an upload destination of the document data in the designation screen 40A, and presses an upload button 40C. Meanwhile, when it is desired to delete the document data stored in the cabinet 20, the user designates the cabinet 20 that stores the document data desired to be deleted in the designation screen 40A, and presses a check box 40E associated with the document data desired to be deleted in the display screen 40B so as to display a check mark in the check box 40E. Then, when the user presses a delete button 40D, the document data that is associated with the check-marked check box 40E is deleted from the designated cabinet 20.

In addition, when it is desired to download the document data stored in the cabinet 20, the user downloads the designated document data by double-clicking the document name of the document data desired to be downloaded using a mouse or the like in the display screen 40B. Then, an application provided in advance for the file format of the downloaded document data is started, and displays the document represented by the downloaded document data. Meanwhile, when it is desired to correct the document data, the user downloads the document data from the cabinet 20, and then, corrects, overwrites, and saves the document data on the application, so that the document data downloaded from the cabinet 20 is corrected.

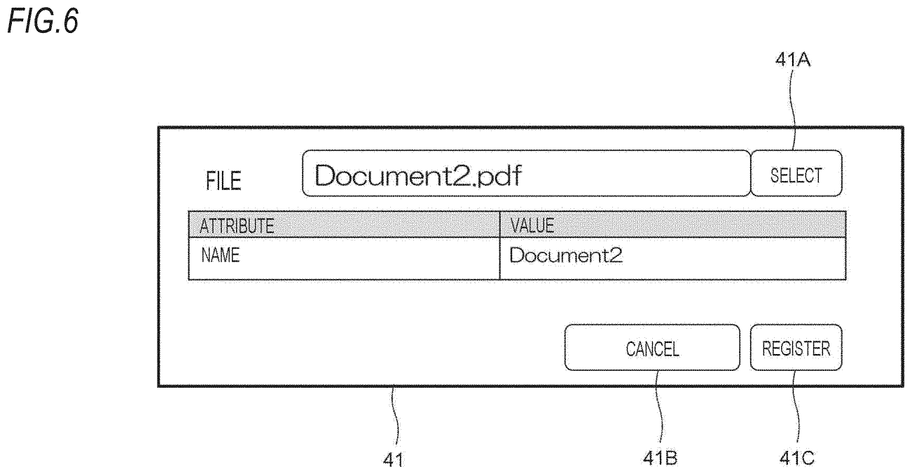

FIG. 6 is a view illustrating an example of an upload screen 41 displayed on the user terminal 3 when the user presses the upload button 40C.

When the user selects a document name of document data desired to be uploaded from a file list display screen (not illustrated) displayed by pressing a selection button 41A, the upload screen 41 displays, for example, attributes of the document data which include a document name, a creation date, and a creator of the selected document data. Then, when the user presses a registration button 41C, the selected document data is uploaded to the cabinet 20 designated in the designation screen 40A of the menu screen 40 of FIG. 5. To stop the upload, the user may press a cancel button 41B.

An information processing program that defines the upload process is stored in advance in, for example, the ROM 32 of the information processing apparatus 10. When the CPU 31 of the information processing apparatus 10 reads the information processing program stored in the ROM 32, the upload process is performed.

In step S10 of FIG. 4, the CPU 31 acquires a data size D of the document data designated as the upload target.

In step S20, the CPU 31 acquires the consumed capacity C and the upper limit capacity Cₘ of the cabinet 20 designated as the upload destination of the document data.

In step S30, in order to check the available capacity of the cabinet 20 designated as the upload destination of the document data, the CPU 31 determines whether a capacity obtained by adding the data size D of the designated document data to the consumed capacity C of the cabinet 20 exceeds the upper limit capacity Cₘ of the cabinet 20. When it is determined that the capacity obtained by adding the data size D of the designated document data to the consumed capacity C of the cabinet 20 is equal to or smaller than the upper limit capacity Cₘ of the cabinet 20, that is, when it is determined that the cabinet 20 has an available capacity, the process proceeds to step S40.

In this case, since the document data designated as the upload target may be stored in the cabinet 20 designated as the upload destination of the document data, the CPU 31 stores the document data of the upload target in the designated cabinet 20, in step S40.

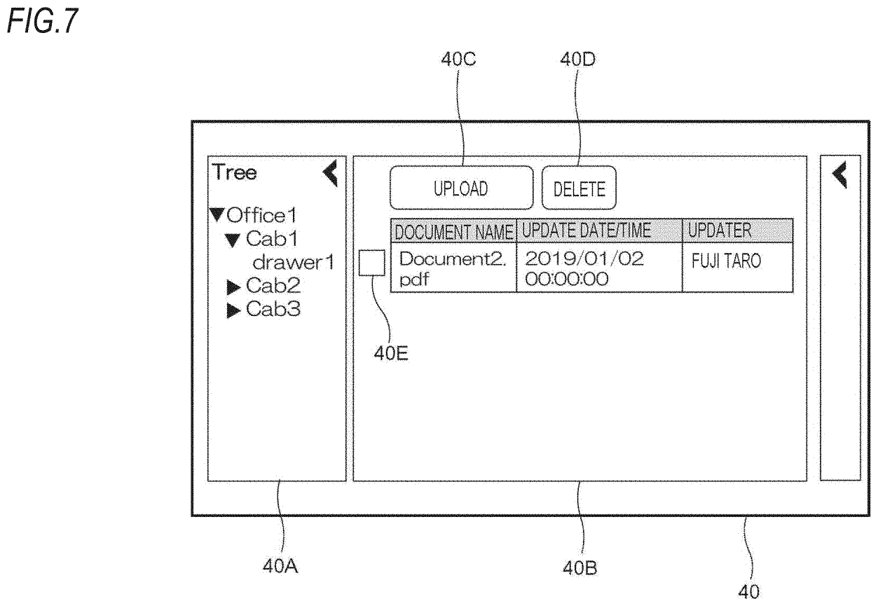

FIG. 7 is a view illustrating an example of the menu screen 40 displayed on the user terminal 3 when the upload of the document data is successful. The display screen 40B displays, for example, the attributes of the document data that has been successfully uploaded.

After the document data is stored in the designated cabinet 20, the CPU 31 re-calculates the consumed capacity C of the cabinet 20 that stores the uploaded document data, by adding the data size D of the document data acquired in step S10 to the consumed capacity C of the cabinet 20 acquired in step S20, in step S50 of FIG. 4.

Then, in step S60, the CPU 31 creates an operation history indicating that the document data of the upload target has been normally uploaded to the designated cabinet 20. Specifically, the CPU 31 creates an operation history that includes, for example, upload date/time, user identification information of the user who has made the upload request, the operation type (the upload operation in this case), the document name of the document data designated as the upload target, the name of the cabinet 20 designated as the upload destination of the document data, user terminal identification information of the user terminal 3 that has transmitted the upload request, and the operation result (“successful” in this case).

Meanwhile, when it is determined in the determination process of step S30 that the designated cabinet 20 has no available capacity, the process proceeds to step S70.

In this case, the document data of the upload target may not be stored in the cabinet 20 designated as the upload destination of the document data. Accordingly, in step S70, in order to show that the document data of the upload target fails to be uploaded to the designated cabinet 20, the CPU 31 creates an operation history in which the operation result is set to “failed”.

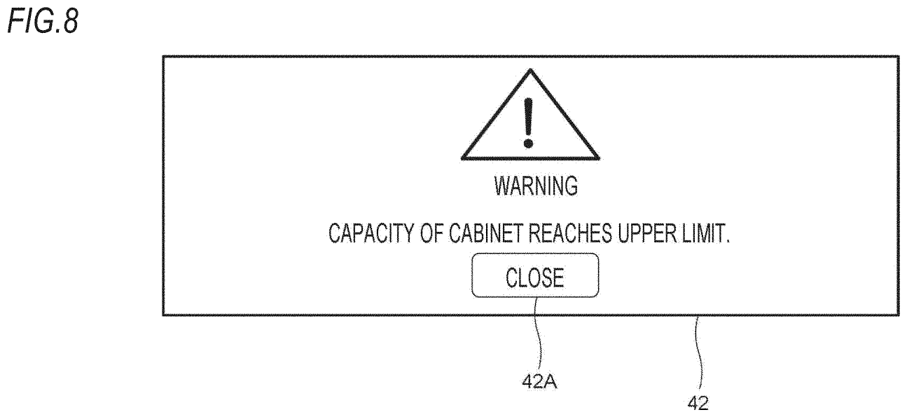

FIG. 8 is a view illustrating an example of a warning screen 42 displayed on the user terminal 3 when the upload of the document data is failed. With the warning screen 42, the user who has made the upload request notices that the cabinet 20 designated as the upload destination of the document data has no available capacity. When the user presses a close button 42A of the warning screen 42, the warning screen 42 disappears from the user terminal 3.

After the operation history is created in step S60 or S70 of FIG. 4, the CPU 31 acquires a data size H of the created operation history in step S80.

In step S90, in order to check whether the cabinet 20 designated as the upload destination of the document data has an available capacity for storing the created operation history, the CPU 31 acquires the current consumed capacity C of the designated cabinet 20. Then, the CPU 31 determines whether a capacity obtained by adding the data size H of the operation history to the acquired consumed capacity C of the cabinet 20 exceeds the upper limit capacity Cₘ of the cabinet 20 acquired in step S20.

When it is determined that the capacity obtained by adding the data size H of the operation history to the consumed capacity C of the cabinet 20 is equal to or smaller than the upper limit capacity Cₘ of the cabinet 20, that is, when the cabinet 20 has an available capacity, the process proceeds to step S100.

In this case, since the operation history may be stored in the cabinet 20 designated as the upload destination of the document data, the CPU 31 stores the operation history in the designated cabinet 20 in step S100, and ends the upload process illustrated in FIG. 4.

Meanwhile, when it is determined in the determination process of step S90 that the available capacity of the cabinet 20 designated as the upload destination of the document data is smaller than the size of the created operation history, the process proceeds to step S10.

In this case, while the created operation history may not be stored in the cabinet 20 designated as the upload destination of the document data, it is necessary to store the operation history in any storage area in preparation for the auditing of data. Accordingly, the CPU 31 stores the created operation history in the system area 21 in step S10, and ends the upload process illustrated in FIG. 4.

Meanwhile, the CPU 31 stores the operation history in the system area 21, even when there is an cabinet 20, other than the designated cabinet 20, that is usable by the user who has made the upload request, and the corresponding cabinet 20 has an available capacity equal to or larger than the size of the created operation history.

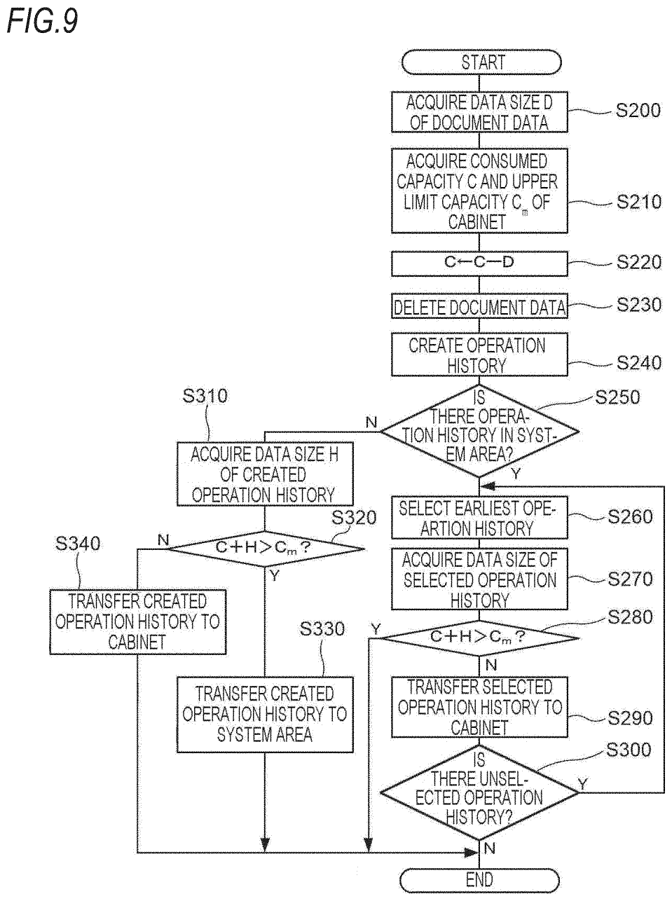

FIG. 9 is a flowchart illustrating an example of the flow of a deleting process performed by the CPU 31 of the information processing apparatus 10, when a request for deleting the document data stored in the cabinet 20 designated by the user is made from the user terminal 3.

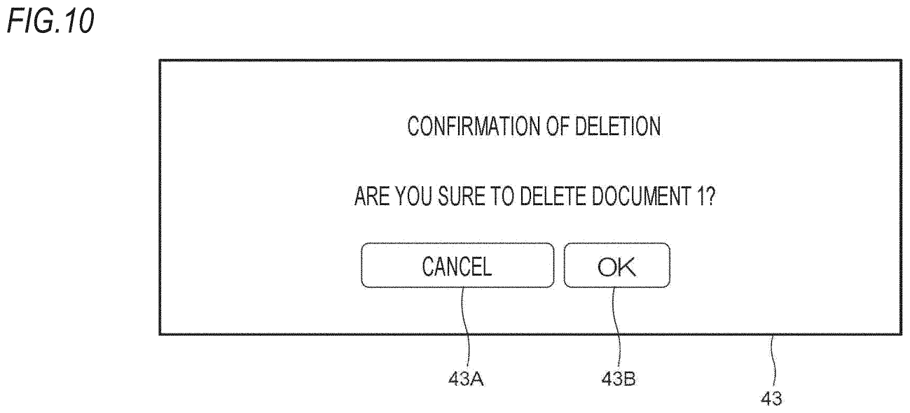

In the designation screen 40A of the menu screen 40 illustrated in FIG. 5, the user designates a cabinet 20 that stores document data desired to be deleted, designates the document data desired to be deleted, and then, presses the delete button 40D. Then, for example, a confirmation screen 43 is displayed in the user terminal 3 as illustrated in FIG. 10. The user confirms whether the document name of the document displayed in the confirmation screen 43 corresponds to the document name of the document desired to be deleted, and presses an OK button 43B when the confirmation result is yes. Meanwhile, when the document name of the document displayed in the confirmation screen 43 does not correspond to the document name of the document desired to be deleted, the user presses a cancel button 43A.

An information processing program that defines the deleting process is stored in advance in, for example, the ROM 32 of the information processing apparatus 10. When the CPU 31 of the information processing apparatus 10 reads the information processing program stored in the ROM 32, the deleting process is performed.

In step S200, the CPU 31 acquires the data size D of the document data stored in the cabinet 20 designated by the deletion request and designated as the deletion target.

In step S210, the CPU 31 acquires the consumed capacity C and the upper limit capacity Cₘ of the cabinet 20 that stores the designated document data.

In step S220, the CPU 31 subtracts the data size D of the document data acquired in step S200 from the consumed capacity C of the cabinet 20 acquired in step S210, and updates the consumed capacity C of the cabinet 20 from which the designated document data has been deleted.

In step S230, the CPU 31 deletes the designated document data from the cabinet 20.

In order to record that the deleting operation has been performed for the document data stored in the cabinet 20, the CPU 31 creates an operation history, in step S240, including, for example, deletion date/time, user identification information of the user who has made the deletion request, an operation type (the deleting operation, in this case), the document name of the document data designated as the deletion target, cabinet identification information of the cabinet 20 that has stored the document data of the deletion target, user terminal identification information of the user terminal 3 that has transmitted the deletion request, and an operation result (“successful” in this case).

As a result of the deleting operation, the cabinet 20 from which the document data has been deleted has a new available capacity. Accordingly, the storage destination of the operation history temporarily stored in the system area 21, that is, the operation history that records the operation of the document data performed in the cabinet 20 from which the document data has been deleted is changed to the original storage destination of the operation history, that is, the cabinet 20 from which the document data has been deleted.

Thus, in step S250, the CPU 31 determines whether the system area 21 includes the operation history including the same cabinet identification information as the cabinet identification information of the cabinet 20 from which the document data has been deleted.

When it is determined that the system area 21 includes the operation history that satisfies the condition, the CPU 31 temporarily stores the operation history created in step S240 in the system area 21. Then, the process proceeds to step S260 in order to change the storage destination of the operation history stored in the system area 21 to the cabinet 20 from which the document data has been deleted.

Since there may be plural operation histories which are subjected to the change of storage destination, the CPU 31 refers to operation dates/times of the operation histories, and selects an operation history recorded with the earliest operation date/time in step S260. For the convenience of description, the operation history selected in step S260 will be referred to as the “selected operation history”.

In step S270, the CPU 31 acquires the data size H of the selected operation history.

In step S280, in order to check whether the cabinet 20 from which the document data has been deleted has an available capacity for storing the selected operation history, the CPU 31 acquires the current consumed capacity C of the cabinet 20 from which the document data has been deleted, and determines whether a capacity obtained by adding the data size H of the selected operation history to the acquired consumed capacity C of the cabinet 20 exceeds the upper limit capacity Cₘ of the cabinet 20 acquired in step S210.

When it is determined that the capacity obtained by adding the data size H of the selected operation history to the consumed capacity C of the cabinet 20 is equal to or smaller than the upper limit capacity Cₘ of the cabinet 20, that is, when the cabinet 20 has an available capacity equal to or larger than the data size H of the selected operation history, the process proceeds to step S290.

In this case, since the selected operation history may be stored in the cabinet 20 that has the available capacity as a result of the deletion of the document data, the CPU 31 transfers the selected operation history to the cabinet 20 from which the document data has been deleted, in step S290. Further, with the transfer of the selected operation history, the CPU 31 updates the consumed capacity C of the cabinet 20 by adding the data size H of the selected operation history to the consumed capacity C of the cabinet 20 acquired in step S280.

In step S300, the CPU 31 determines whether the operation histories that satisfy the determination condition in step S250 include unselected operation histories that have not yet been selected in step S260. When it is determined that unselected operation histories exist, the process proceeds to step S260, and an operation history recorded with the earliest operation date/time among the unselected operation histories is selected as a new selected operation history.

The processes of steps S260 to S300 are repeatedly performed until it is determined in the determination process of step S300 that an unselected operation history no longer exists. As a result, the operation histories that are temporarily stored in the system area 21 and are to be stored in the cabinet 20 from which the document data has been deleted are stored in the cabinet 20 in an order from the earliest operation history until the upper limit capacity Cₘ of the cabinet 20 is reached.

When it is determined in the determination process of step S300 that no unselected operation history exists, the deleting process illustrated in FIG. 9 is ended, since the storage destinations of all of the operation histories to be stored in the cabinet 20 from which the document data has been deleted have been changed from the system area 21 to the cabinet 20.

In addition, when it is determined in the determination process of step S280 that the cabinet 20 has no available capacity, the deleting process illustrated in FIG. 9 is ended, since the storage destinations of the operation histories stored in the system area 21 may not be changed to the cabinet 20 any more.

Meanwhile, when it is determined in the determination process of step S250 that the system area 21 does not include the operation history satisfying the determination condition, the process proceeds to step S310.

In step S310, the CPU 31 acquires the data size H of the operation history created in step S240.

In step S320, in order to check whether the cabinet 20 from which the document data has been deleted has an available capacity for storing the operation history created in step S240, the CPU 31 determines whether the capacity obtained by adding the data size H of the operation history created in step S240 to the consumed capacity C of the cabinet 20 updated in step S220 exceeds the upper limit capacity Cₘ of the cabinet 20 acquired in step S210.

When it is determined that the capacity obtained by adding the data size H of the created operation history to the consumed capacity C of the cabinet 20 exceeds the upper limit capacity Cₘ of the cabinet 20, that is, when the cabinet 20 has no available capacity, the process proceeds to step S330.

In this case, since the operation history created in step S240 may not be stored in the cabinet 20 from which the document data has been deleted, the created operation history is transferred to the system area 21, and the deleting process illustrated in FIG. 9 is ended.

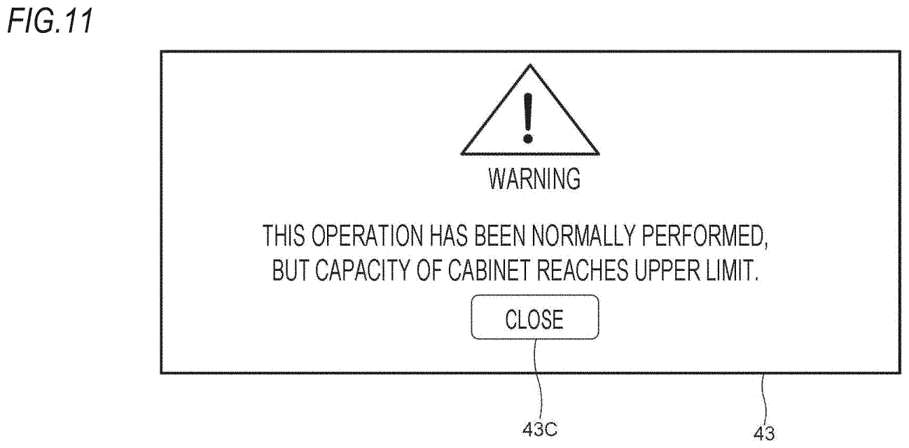

FIG. 11 is a view illustrating an example of the confirmation screen 43 displayed in the user terminal 3 when the cabinet 20 from which the document data has been deleted has no available capacity, and the created operation history is stored in the system area 21. As illustrated in FIG. 11, the confirmation screen 43 displays “This operation has been normally performed, but the capacity of the cabinet reaches the upper limit”, and the user who has made the deletion request notices that the cabinet 20 has no available capacity for storing the operation history even though the document data has been deleted from the cabinet 20. When the user presses a close button 43C of the confirmation screen 43, the confirmation screen 43 disappears from the user terminal 3.

Meanwhile, when it is determined in the determination process of step S320 that the cabinet 20 has an available capacity, the process proceeds to step S340. In step S340, the CPU 31 transfers the operation history created in step S240 to the cabinet 20 from which the document data has been deleted, and ends the deleting process illustrated in FIG. 9.

In steps S280 and S320 of FIG. 9, the CPU 31 determines whether the capacity obtained by adding the data size H of the operation history to the consumed capacity C of the cabinet 20 exceeds the upper limit capacity Cₘ of the cabinet 20, and checks whether the cabinet 20 has an available capacity. When the capacity obtained by adding the data size H of the operation history to the consumed capacity C of the cabinet 20 is equal to the upper limit capacity Cₘ of the cabinet 20, it is determined that the cabinet 20 has an available capacity for storing the operation history, and thus, the CPU 31 stores the operation history in the cabinet 20.

However, in this case, since the operation history is stored in the cabinet 20, the cabinet 20 no longer has an available capacity. Accordingly, for example, when requests for uploading document data to the same cabinet 20 are continuously received from the user terminals 3, all of the subsequent upload requests are failed even when the upload requests relate to storing highly urgent document data in the cabinet 20, as long as document data is not deleted from the cabinet 20.

In order to prevent the occurrence of the circumstance, the cabinet 20 may assure an available capacity at least equal to or larger than a predetermined capacity (hereinafter, referred to as “specified capacity Q”).

Specifically, in the determination processes of steps S280 and S320 of FIG. 9, the CPU 31 may determine whether a capacity obtained by adding the data size H of the operation history and the specified capacity Q to the consumed capacity C of the cabinet 20 exceeds the upper limit capacity Cₘ of the cabinet 20. That is, when the cabinet 20 has an available capacity equal to or larger than the specified capacity Q even though the operation history is stored in the cabinet 20, the CPU 31 stores the operation history in the cabinet 20.

Meanwhile, in the information processing apparatus 10, the size of the operation history may be divided and managed in, for example, a predetermined unit, in order to simplify the management of the operation history. For example, when the division unit is 5 MB, an operation history of 11.5 MB is included in a divided part of more than 10 MB and 15 MB or less. Accordingly, the CPU 31 may regard the upper limit capacity of the divided part that includes the size of the operation history (15 MB in this case), as the size of the operation history, and may check an available capacity.

In the deleting process illustrated in FIG. 9, when the cabinet 20 from which the document data has been deleted has an available capacity, and the system area 21 includes the operation history having the same cabinet identification information as the cabinet identification information of the cabinet 20 from which the document data has been deleted, the storage destination of the operation history is changed from the system area 21 to the cabinet 20 each time document data is deleted from the cabinet 20.

However, the CPU 31 may not change the storage destination of the operation history from the system area 21 to the cabinet 20 in step S290 of FIG. 9, and may only mark the operation history that is subjected to the change of storage destination, in order to discriminate the operation history subjected to the change of storage destination at a later time. Then, the CPU 31 may store each marked operation history in the cabinet 20 represented by the user identification information included in the operation history, at the time when a periodic process is performed such as a daily process performed at a predetermined interval such as once a day, or at a timing instructed by the user.

Even though the CPU 31 only mark the operation history without transferring the operation history from the system area 21 to the cabinet 20 in step S290, the CPU 31 may update the consumed capacity C of the cabinet 20 by adding the data size H of the marked operation history to the consumed capacity C of the cabinet 20, so that the cabinet 20 may secure an area for storing the marked operation history. Accordingly, even when the operation history stored in the system area 21 is transferred to the cabinet 20 at any timing, it is assured that each marked operation history is stored in the cabinet 20 represented by the user identification information included in the operation history.

Descriptions have been made on an example where the operation history stored in the system area 21 is transferred to the cabinet 20 when a deletion request is received from the user. However, the operation history stored in the system area 21 may be transferred to the cabinet 20 by performing step S240 shown in FIG. 9 and the subsequent steps thereof after an operation to correct the document data is performed, or the operation history stored in the system area 21 may be marked, and the marked operation history may be transferred to the cabinet 20 at a later time.

As described above, in the information processing apparatus 10 according to the first exemplary embodiment, when the user performs an operation on a document, an available capacity of the cabinet 20 designated by the operation on the document is checked. The information processing apparatus 10 stores the operation history in the cabinet 20 when the cabinet 20 has an available capacity for storing the operation history, and stores the operation history in the system area 21 when the cabinet 20 has no available capacity. Then, when the consumed capacity C of the cabinet 20 is reduced as a result of, for example, the process of deleting document data, the operation history of the operation of the document data that has been performed for the cabinet 20 with the reduced consumed capacity C is transferred from the system area 21 to the corresponding cabinet 20.

### Second Exemplary Embodiment

In the first exemplary embodiment, when the user performs an operation on a document, it is checked whether the cabinet 20 designated by the operation on the document has an available capacity, and the operation history is stored in the cabinet 20 when the cabinet 20 has an available capacity for storing the operation history.

In a second exemplary embodiment, descriptions will be made on an example of an information processing apparatus 10 that temporarily stores all operation histories in the system area 21 even when a cabinet 20 designated by an operation on a document has an available capacity for storing an operation history.

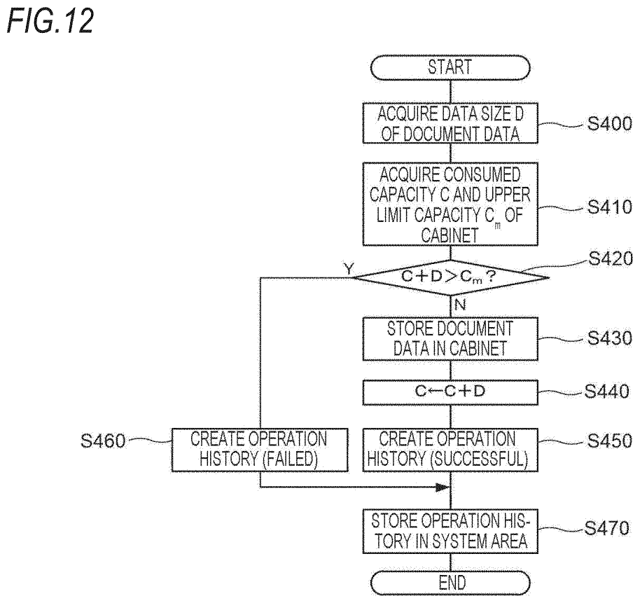

FIG. 12 is a flowchart illustrating an example of the flow of an upload process performed by the CPU 31 of the information processing apparatus 10 according to the second exemplary embodiment, when a request for uploading document data to a cabinet 20 designated by a user is received from the user terminal 3.

An information processing program that defines the upload process in the second exemplary embodiment is stored in advance in, for example, the ROM 32 of the information processing apparatus 10. When the CPU 31 of the information processing apparatus 10 reads the information processing program stored in the ROM 32, the upload process according to the second exemplary embodiment is performed.

First, in step S400, the CPU 31 acquires the data size D of the document data designated as the upload target.

In step S410, the CPU 31 acquires the consumed capacity C and the upper limit capacity Cₘ of the cabinet 20 designated as the upload destination of the document data.

In step S420, in order to check an available capacity of the cabinet 20 designated as the upload destination of the document data, the CPU 31 determines whether a capacity obtained by adding the data size D of the designated document data to the consumed capacity C of the cabinet 20 acquired in step S410 exceeds the upper limit capacity Cₘ of the cabinet 20 acquired in step S410. When it is determined that the capacity obtained by adding the data size D of the designated document data to the consumed capacity C of the cabinet 20 is equal to or smaller than the upper limit capacity Cₘ of the cabinet 20, that is, when it is determined that the cabinet 20 has an available capacity, the process proceeds to step S430.

In this case, since the document data designated as the upload target may be stored in the cabinet 20 designated as the upload destination of the document data, the CPU 31 stores the document data of the upload target in the designated cabinet 20 in step S430. In addition, with the successful upload of the document data, the CPU 31 may cause the user terminal 3 which is the transmission source of the upload request to display the menu screen 40 illustrated in FIG. 7 to notify the user of the successful upload of the document data.

In step S440 of FIG. 12, the CPU 31 updates the consumed capacity C of the cabinet 20 that stores the uploaded document data, by adding the data size D of the document data acquired in step S400 to the consumed capacity C of the cabinet 20 acquired in step S410.

In step S450, in order to record that the document data of the upload target has been normally uploaded to the designated cabinet 20, the CPU 31 creates an operation history in which the operation result is set to “successful”. In addition, the operation history includes the items described above in step S60 of FIG. 4.

Meanwhile, when it is determined in the determination process of step S420 that the designated cabinet 20 has no available capacity, the process proceeds to step S460, and the CPU 31 creates an operation history in which the operation result is set to “failed”, in order to record that the document data of the upload target may not be uploaded to the designated cabinet 20.

With the failed upload of the document data, the CPU 31 may cause the user terminal 3 which is the transmission source of the upload request to display the warning screen 42 illustrated in FIG. 8, to notify the user of the failed upload of the document data.

After the operation history is created in step S450 or S460 of FIG. 12, the CPU 31 stores the created operation history in the system area 21, in step S470, without checking whether the cabinet 20 designated as the upload destination of the document data has an available capacity for storing the created operation history, and ends the upload process illustrated in FIG. 12.

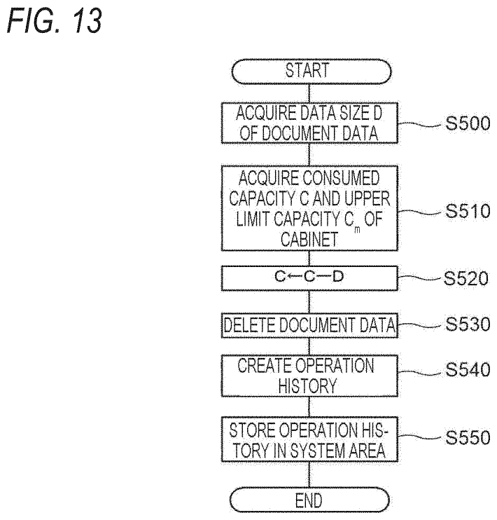

FIG. 13 is a flowchart illustrating an example of the flow of a deleting process performed by the CPU 31 of the information processing apparatus 10 according to the second exemplary embodiment, when a request for deleting the document data stored in the cabinet 20 designated by the user is received from the user terminal 3.

An information processing program that defines the deleting process according to the second exemplary embodiment is stored in advance in, for example, the ROM 32 of the information processing device 10. When the CPU 31 of the information processing apparatus 10 reads the information processing program stored in the ROM 32, the deleting process of the second exemplary embodiment is performed.

In step S500, the CPU 31 acquires the data size D of the document data stored in the cabinet 20 designated by the deletion request and designated as the deletion target.

In step S510, the CPU 31 acquires the consumed capacity C and the upper limit capacity Cₘ of the cabinet 20 that stores the designated document data.

In step S520, the CPU 31 subtracts the data size D of the document data acquired in step S500 from the consumed capacity C of the cabinet 20 acquired in step S510, and updates the consumed capacity C of the cabinet 20 from which the designated document data has been deleted.

In step S530, the CPU 31 deletes the designated document data from the cabinet 20.

In order to record that the deleting operation has been performed for the document data stored in the cabinet 20, the CPU 31 creates an operation history in step S540. In addition, the operation history includes the items described above in step S240 of FIG. 9.

While the cabinet 20 from which the document data has been deleted has an available capacity, the CPU 31 stores the operation history created in step S540 in the system area 21 in step S550, without checking the available capacity of the cabinet 20, and ends the deleting process illustrated in FIG. 13.

Descriptions have been made on the method of storing the operation history when the request for the upload process or the deleting process is received from the user. However, when a correction is made to the document data, the CPU 31 also stores the operation history created accompanied by the correcting operation in the system area 21, without checking the available capacity of the cabinet 20.

Thus, the CPU 31 performs the process of changing the storage destination of the operation history from the system area 21 to the cabinet 20, each time a predetermined process is performed. The predetermined process may be any process that is performed by the information processing apparatus 10. The predetermined process may be a process which is repeatedly performed, or a process of detecting an available capacity of the cabinet 20, that is, a change in consumed capacity C of the cabinet 20, in order to prevent operation histories from being continuously and permanently stored in the system area 21. Specifically, the changing process may be performed when the consumed capacity C of the cabinet 20 exceeds a predetermined capacity, or when a periodic process is performed such as a daily process performed once a day. In addition, the changing process may be performed after a process of increasing the available capacity of the cabinet 20 is performed, like the deleting process illustrated in FIG. 13.

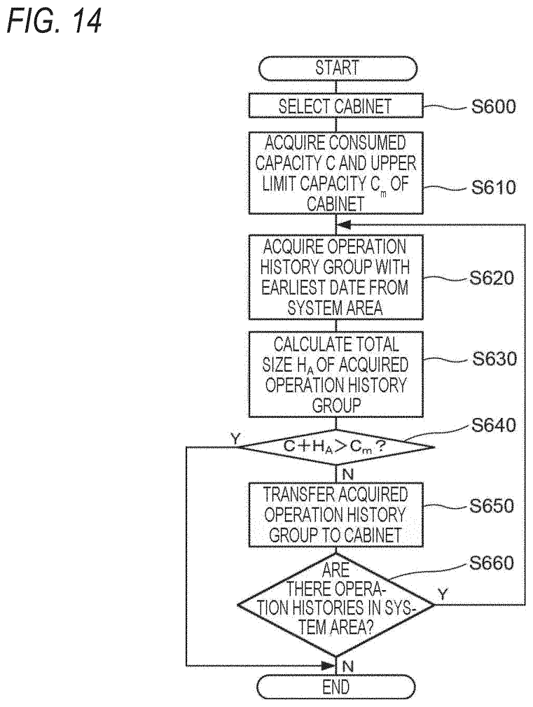

FIG. 14 is a flowchart illustrating an example of the flow of the changing process performed by the CPU 31 of the information processing apparatus 10.

An information processing program that defines the changing process is stored in advance in, for example, the ROM 32 of the information processing apparatus 10. When the CPU 31 of the information processing apparatus 10 reads the information processing program stored in the ROM 32, the changing process is performed.

In step S600, the CPU 31 refers to cabinet identification information of operation histories stored in the system area 21, and selects one cabinet 20 from the cabinets 20 where the operations represented by the operation histories stored in the system area 21 have been performed. For the convenience of description, the cabinet 20 selected in step S600 will be referred to as the “selected cabinet 20”.

In step S610, the CPU 31 acquires the consumed capacity C and the upper limit capacity Cₘ of the selected cabinet 20.

In step S620, the CPU 31 classifies operation histories of the selected cabinet 20 that have been stored in the system area 21, in units of a predetermined time period according to the operation dates/times included in the operation histories. The process of classifying the operation histories in units of a predetermined time period according to the operation dates/times included in the operation histories refers to gathering operation histories with the operation dates/times that belong to the same time period, and forming an operation history group. For example, when the operation histories are classified in units of one day, the operation histories are classified into an operation history group for Oct. 1, 2019 and an operation history group for Oct. 2, 2019, for each cabinet 20. The time period unit for classifying the operation histories is not limited, and the operation histories may be classified in units of hour, week, or month. Here, an example where the operation histories of the selected cabinet 20 are classified in units of one day will be described.

The CPU 31 acquires operation histories stored on the earliest day from the operation histories of the selected cabinet 20 that have been stored in the system area 21 and classified in units of one day, that is, an operation history group with the earliest classification date from the operation histories of the selected cabinet 20 that have been stored in the system area 21.

In step S630, the CPU 31 calculates a total size H_{A} of the operation history group for one day that has been acquired in step S620.

In step S640, in order to check an available capacity of the selected cabinet 20, the CPU 31 determines whether a capacity obtained by adding the total size H_{A} of the operation history group for one day that has been calculated in step S630 to the consumed capacity C of the selected cabinet 20 acquired in step S610 exceeds the upper limit capacity Cₘ of the selected cabinet 20 acquired in step S610. When it is determined that the capacity obtained by adding the total size H_{A} of the operation history group for one day to the consumed capacity C of the selected cabinet 20 exceeds the upper limit capacity Cₘ of the selected cabinet 20, that is, when the selected cabinet 20 has no available capacity, the changing process illustrated in FIG. 14 is ended, since the operation history group for one day acquired in step S620 may not be collectively transferred to the selected cabinet 20.

Meanwhile, when it is determined that the selected cabinet 20 has an available capacity, the operation history group of the selected cabinet 20 for one day that has been stored in the system area 21 may be collectively stored in the selected cabinet 20. Accordingly, in step S650, the CPU 31 transfers the operation history group for one day acquired in step S620 to the selected cabinet 20, and changes the storage destination of the operation history group to the selected cabinet 20. That is, the operation history group for one day acquired in step S620 is deleted from the system area 21.

In step S660, the CPU 31 checks whether the operation histories of the selected cabinet 20 yet exist in the system area 21, and when the operation histories exist, the process proceeds to step S620.

As described above, in step S620, the CPU 31 acquires an operation history group with the earliest classification date, among the operation history groups of the selected cabinet 20 that have been stored in the system area 21 and classified in units of one day. Accordingly, the CPU 31 repeatedly performs the processes of steps S620 to S660, so that the operation history groups that have been stored in the system area 21 and classified in units of one day are stored in the selected cabinet 20 in an order from an operation history group stored on the earliest day, as long as the selected cabinet 20 has an available capacity, in the scope that does not exceed the available capacity of the selected cabinet 20.

When it is determined in the determination process of step S660 that the operation histories of the selected cabinet 20 do not exist in the system area 21, the changing process illustrated in FIG. 14 is ended, since all of the operation histories of the selected cabinet 20 that are stored in the system area 21 have been transferred to the selected cabinet 20.

In addition, when there are plural cabinets 20 in which an operation represented by an operation history stored in the system area 21 has been performed, the CPU 31 repeats the changing process illustrated in FIG. 14 until all of the cabinets 20 are selected as selected cabinets 20 in step S600.

As described in the first exemplary embodiment, in step S640 of FIG. 14 as well, the CPU 31 may determine whether the capacity obtained by adding the total size H_{A} of the operation history group for one day and the specified capacity Q to the consumed capacity C of the selected cabinet 20 exceeds the upper limit capacity Cₘ of the selected cabinet 20. That is, when the cabinet 20 has an available capacity equal to or larger than the specified capacity Q even though operation histories are stored in units of a predetermined time period in the cabinet 20, the CPU 31 stores the operation history group in the cabinet 20.

In addition, as described in the first exemplary embodiment, when the information processing apparatus 10 manages the total size H_{A} of the operation history group stored for each time period in units of a predetermined divided part, the CPU 31 may regard an upper limit capacity of a divided part including the total size H_{A} of the operation history group for each time period, as the total size H_{A} of the operation history group for each time period, and may check an available capacity.

In the changing process illustrated in FIG. 14, when an operation history is stored in the system area 21, the available capacity of the cabinet 20 where the operation represented by the operation history has been performed is checked, and then, the storage destination of the operation history is changed from the system area 21 to the cabinet 20.

In this regard, since the provider of the information processing system 1 needs to increase the storage capacity of the system area 21 as the total size of operation histories temporarily stored in the system area 21 increases, the management costs increase. Thus, the provider of the information processing system 1 may set a free-of-charge storage capacity which is usable by each contracting company in the system area 21, according to a contract with the contracting company for the document management service provided by the information processing system 1. When the total size of operation histories stored in the system area 21 does not exceed the free-of-charge storage capacity, the contracting company may use the system area 21 without paying for the use, but when the total size of operation histories exceeds the free-of-charge storage capacity, the contracting company may pay fees for using the system area 21 to the provider of the information processing system 1 according to the excessive capacity.

In a case where this contract is made, even though operation histories have been stored in the system area 21, the information processing apparatus 10 may not perform the changing process along with the periodic process, for example, until the total size of the operation histories for each contracting company temporarily stored in the system area 21 exceeds the upper limit of each free-of-charge storage capacity. When the total size of the operation histories exceeds the upper limit of the free-of-charge storage capacity, the information processing apparatus 10 may perform a control to perform the changing process in accordance with the periodic process. Then, the load of the information processing apparatus 10 caused from performing the changing process is reduced, as compared with a case where the changing process is performed in accordance with the periodic process each time operation histories are stored in the system area 21. Further, from the viewpoint of the contracting company, since operation histories may be stored in the system area 21 as much as the free-of-charge storage capacity, the capacity of the cabinet 20 may be effectively used without paying additional fees.

In the system area 21 provided by the provider of the information processing system 1, the free-of-charge quota for storing operation histories may be set according to not only a storage capacity but also a storage time period. For example, when the time period for the free-of-charge storage service of operation histories in the system area 21 is set to one year, the CPU 31 of the information processing apparatus 10 does not perform the changing process illustrated in FIG. 14 for operation histories stored in the system area 21 for one year or shorter, and selects operation histories stored in the system area 21 for a time period more than one year as targets subjected to the change of storage destinations in the changing process illustrated in FIG. 14.

In addition, an example where a storage destination of an operation history is changed from the system area 21 to the cabinet 20 in units of a predetermined time period has been described. However, in step S620 of FIG. 14, the earliest operation history among the operation histories of the cabinet 20 may be acquired, instead of acquiring the operation history group of the selected cabinet 20 that is included in the earliest time period. That is, the information processing apparatus 10 may change a storage destination of an operation history from the system area 21 to the cabinet 20 for each operation history.

In this case as well, to check an available capacity of the cabinet 20, the following aspect may be applied: checking an available capacity of the cabinet 20 in consideration of the specified capacity Q; or managing a size of an operation history in units of a divided part, and regarding an upper limit capacity of a divided part including the size of the operation history, as the size of the operation history.

Further, an example where the changing process is performed in accordance with a periodic process such as a daily process has been described. However, the information processing apparatus 10 may allow the changing process illustrated in FIG. 14 to be performed after the deleting process illustrated in FIG. 13 is performed. In this case, the change of a storage destination of an operation history from the system area 21 to the cabinet 20 may be performed in units of a predetermined time period or units of an operation history.

In addition, the information processing apparatus 10 may not necessarily transfer an operation history from the system area 21 to the cabinet 20 in the changing process performed after the deleting process. For example, the information processing apparats 10 may only mark an operation history subjected to the change of storage destination from the system area 21 to the cabinet 20, and instead, may update the consumed capacity C of the cabinet 20 which is the storage destination of the operation history, by adding the data size H of the marked operation history to the consumed capacity C of the cabinet 20, so that the cabinet 20 assures the area for storing the marked operation history.

Then, when operation histories stored in the system area 21 are checked after a periodic process is performed, and a marked operation history is detected, the information processing apparatus 10 changes a storage destination of the marked operation history to the cabinet 20 represented by the cabinet identification information of the operation history, until no marked operation history is detected from the system area 21.

As described above, according to the information processing apparatus 10 of the second exemplary embodiment, even though the cabinet 20 designated by operations on a document has had an available capacity for storing operation histories, all of the operation histories are temporarily stored in the system area 21, and storage destinations of the operation histories are changed from the system area 21 to the cabinet 20 in accordance with the performance of a periodic process or the deleting process.

While the present disclosure has been described using exemplary embodiments, the present disclosure is not limited to the scope described in each of the exemplary embodiments. Various modifications or improvements may be made to each of the exemplary embodiments without departing from the gist of the present disclosure, and forms implemented from making the modifications or improvements are also included in the technical scope of the present disclosure. For example, the order of performing processes may be changed without departing from the gist of the present disclosure.

In each of the exemplary embodiments, for example, an aspect where each process is implemented by software has been described. However, processes equivalent to the flowcharts illustrated in FIGS. 4, 9, and 12 to 14 may be built in, for example, an ASIC (application specific integrated circuit), an FPGA (field programmable gate array), or a PLD (programmable logic device), and may be performed by hardware. In this case, the processes may be performed at a high speed, as compared with a case where each process is implemented by software.

In this way, the CPU 31 may be replaced with a dedicated processor which is specialized in a specific process, such as an ASIC, an FPGA, a PLD, a GPU (graphics processing unit), or an FPU (floating point unit).

The operation of the CPU 31 in each of the exemplary embodiments may be implemented by not only a single CPU 31 but also plural CPUs 31. Further, the operation of the CPU 31 in each of the exemplary embodiments may be implemented by a cooperation of CPUs 31 in computers 30 present at physically separated positions.

In addition, in each of the exemplary embodiments described above, an aspect where the information processing program is installed in the ROM 32 has been described. However, the present disclosure is not limited thereto. The information processing program according to the present disclosure may be provided in a form of being recorded on a computer-readable storage medium. For example, the information processing program may be provided in a form of being recorded on an optical disc such as a CD (compact disk)-ROM or a DVD (digital versatile disk)-ROM. Alternatively, the information processing program according to the present disclosure may be provided in a form of being recorded in a portable semiconductor memory such as a USB memory or a memory card.

Further, the information processing apparatus 10 may acquire the information processing program according to the present disclosure from an external device (not illustrated) connected to the communication line 2, via the communication unit 37.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
store an operation history of an operation performed for a first storage area allocated to a user, in a second storage area that is not allocated to any user; and
check an available capacity of the first storage area each time a predetermined process is performed, and when the first storage area has the available capacity equal to or larger than at least a size of the operation history, perform control to change a storage destination of the operation history from the second storage area to the first storage area.

2. The information processing apparatus according to claim 1, wherein when the available capacity of the first storage area is smaller than the size of the operation history, the processor performs control so as to store the operation history in the second storage area.

3. The information processing apparatus according to claim 2, wherein when a plurality of first storage areas is allocated to the same user, even though another first storage area that is different from the first storage area for which the operation has been performed and is allocated to the same user as the user who has performed the operation has an available capacity equal to or larger than the size of the operation history, the processor stores the operation history including identification information that identifies the first storage area for which the operation has been performed by the user, in the second storage area.

4. The information processing apparatus according to claim 3, wherein each time the predetermined process is performed, the processor checks the available capacity of the first storage area represented by the identification information included in the operation history stored in the second storage area, and when the first storage area has the available capacity equal to or larger than at least the size of the operation history, the processor performs the control so as to change the storage destination of the operation history from the second storage area to the first storage area represented by the identification information.

5. The information processing apparatus according to claim 1, wherein the predetermined process is a periodic process that is performed by the processor at a predetermined interval.

6. The information processing apparatus according to claim 5, wherein each time the periodic process is performed, the processor checks the available capacity of the first storage area, and when the first storage area has the available capacity equal to or larger than a total size of operation histories stored in at least the earliest time period among operation histories that are classified in units of a predetermined time period and stored in the second storage area, the processor performs control to change storage destinations of the operation histories stored in the earliest time period, from the second storage area to the first storage area.

7. The information processing apparatus according to claim 6, wherein the processor stores the operation histories in an order from operation histories stored in the earliest time period in units of the predetermined time period, in the first storage area within a scope that does not exceed the available capacity of the first storage area.

8. The information processing apparatus according to claim 6, wherein when an available capacity equal to or larger than a predetermined capacity is left in the first storage area even though the operation histories stored in the second storage area are stored in the first storage area in units of the predetermined time period, the processor performs control to change storage destinations of the operation histories stored in the second storage area in units of the predetermined time period to the first storage area.

9. The information processing apparatus according to claim 6, wherein the processor manages a total size of the operation histories stored in each time period in units of a predetermined divided part, and regards an upper limit capacity of a divided part including the total size of the operation histories as the total size of the operation histories stored in each time period.

10. The information processing apparatus according to claim 1, wherein the predetermined process is a process of deleting document data from the first storage area that is performed according to an instruction from the user.

11. The information processing apparatus according to claim 10, wherein each time the deleting process is performed, the processor checks the available capacity of the first storage area, and when the first storage area has the available capacity equal to or larger than at least the size of the operation history, the processor performs the control to change the storage destination of the operation history from the second storage area to the first storage area.

12. The information processing apparatus according to claim 11, wherein when there is a plurality of the operation histories in the second storage area, the processor stores the operation histories in an order from an operation history stored in the earliest time period in the first storage area within a scope that does not exceed the available capacity of the first storage area.

13. The information processing apparatus according to claim 1, wherein when an available capacity equal to or larger than a predetermined capacity is left in the first storage area even though the operation history stored in the second storage area is stored in the first storage area, the processor performs control to change the storage destination of the operation history from the second storage area to the first storage area.

14. The information processing apparatus according to claim 1, wherein the processor manages the size of the operation history in units of a predetermined divided part, regards an upper limit capacity of the divided part including the size of the operation history as the size of the operation history, and checks the available capacity of the first storage area.

15. A non-transitory computer readable medium storing a program causing a computer to execute information processing, the information processing comprising:
storing an operation history of an operation performed for a first storage area allocated to a user, in a second storage area that is not allocated to any user; and
checking an available capacity of the first storage area each time a predetermined process is performed, and when the first storage area has the available capacity equal to or larger than at least a size of the operation history, performing control to change a storage destination of the operation history from the second storage area to the first storage area.

16. An information processing apparatus comprising:
means for
storing an operation history of an operation performed for a first storage area allocated to a user, in a second storage area that is not allocated to any user, and
checking an available capacity of the first storage area each time a predetermined process is performed, and when the first storage area has the available capacity equal to or larger than at least a size of the operation history, performing control to change a storage destination of the operation history from the second storage area to the first storage area.
